(19) United States
(12) Patent Application Publication
(10) Pub. No.: US 2004/0026901 A1
(43) Pub. Date: Feb. 12, 2004

(54) Strap connection and a method of connecting a strap

(76) Inventors: Deligny Yann, Compiegne (FR); Guido Satzger, Munchen (DE); Ridvan Oral, Mainburg (DE)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/381,959

(22) PCT Filed: Oct. 1, 2001
(86) PCT No.: PCT/SE01/02108

(30) Foreign Application Priority Data
Oct. 3, 2000 (GB) 0024171.1

(51) Int. Cl. B60R 21/00

(52) U.S. Cl. 280/727

(57) ABSTRACT

A strap fixing comprises a strap (5) and an aperture (2) formed in part of a motor vehicle. An end part of the strap is folded over twice (6, 7) and is then stitched (10) to form a second end region. The aperture has a first region (3) dimensioned to permit the end part of the strap to be inserted through the aperture. The aperture defines a second region (4) designed snugly to accommodate and retain the flat strap. If force is applied to the strap tending to withdraw the strap from the aperture when the strap is in the second region (4), the strap will be retained within the second region and the end part of the strap will engage the periphery of the aperture.

The present invention relates to a strap connection and, more particularly, relates to a strap connection between an end part of a strap and part of a motor vehicle.

It is often necessary to connect an end part of a strap to part of the body of a motor vehicle. One example of where a strap connection of this type is required is with an inflatable element in the form of an inflatable side curtain such as that shown in GB-A-2,297,950.

It has been proposed previously to mount straps on a motor vehicle using mounting plates, bolts or hooks. The present invention seeks to provide an improved strap connection.

According to this invention there is provided a strap connection comprising a strap and an aperture formed in part of the motor vehicle, the strap comprising a substantially flat strap having a terminal part folded over at least once to create an end region comprising at least two adjacent layers of strap, the said adjacent layers of strap being permanently fixed together over at least part of the region in which they are adjacent, the aperture being configured and dimensioned to permit the end region of the strap to be inserted through the aperture and to accommodate and retain the flat strap so that when a force is applied to the strap tending to withdraw the strap from the aperture the end region of the strap will engage part of the vehicle adjacent the periphery of the aperture to prevent the end region passing through the aperture.

Preferably the end of the strap is folded over twice to create said end part, the end part thus having three layers of strap.

Conveniently the adjacent layers of strap are permanently fixed together by stitching. Alternatively the adjacent layers may be welded or adhered together.

Preferably the said adjacent layers are permanently fixed together only over a part of the region where they are adjacent to define a free tab adjacent the main part of the strap, the free tab being adapted to be the component of the end part to engage the part of the vehicle adjacent the periphery of the aperture.

Preferably the aperture has a first region dimensioned to permit the end region of the strap to be inserted therethrough and a second region, which is connected to the first region, which is dimensioned to accommodate and retain the main body of the flat strap.

Conveniently the first region and the second region are interconnected by a zone having a width less than the width of the strap.

Advantageously a cover is provided adapted to cover the part of the aperture not occupied by the strap when the strap is in the second region. The cover may be a snap-in cover adapted to be snapped into the part of the aperture not occupied by the strap. The cover may completely cover this part of the aperture, or may partially cover this part of the aperture.

In an alternative embodiment the aperture is a substantially rectangular aperture having a predetermined width and a predetermined height, the width being slightly greater than the width of the flat strap.

Conveniently the height of the aperture is greater than the thickness of the end region where said layers of said strap are fixed together, the end region having a part where the layers are not fixed together, that part having an initial thickness greater than the height of the aperture, but being resiliently compressible.

Preferably the strap is connected to an inflatable element in the form of an inflatable side curtain.

Conveniently the aperture is formed in the A-pillar of the car body.

The invention also relates to a method of connecting a substantially flat strap to an aperture formed in part of a motor vehicle, the method comprising the steps of folding a terminal part of the strap over at least once to create an end region comprising at least two adjacent layers of strap and permanently fixing the adjacent layers of strap together at least over a part of the region in which they are adjacent, inserting the end region through the aperture and positioning the strap so that when a force is applied to the strap tending to withdraw the strap from the aperture the end region of the strap will engage part of the vehicle adjacent the periphery of the aperture to prevent the end region passing through the aperture.

Preferably the end of the strap is folded over twice to create the end region, the end region thus having three layers of strap.

Conveniently the adjacent layers of straps are permanently fixed together by stitching.

Advantageously the adjacent layers are permanently fixed together only over the part of the region in which they are adjacent to define in the other part of the region a free tab adjacent the main strap, the free tab being the component of the end region which engages the part of the vehicle adjacent the periphery of the aperture when said force is applied to the strap tending to withdraw the strap from the aperture.

In one embodiment the aperture is provided with a first region dimensioned to permit the end region of the strap to be inserted therethrough and a second region to accommodate and retain the flat strap, the method comprising the steps of inserting the end region of the strap through the first region of the aperture and manipulating the flat strap so that it is located in the second region of the aperture.

In another embodiment the aperture is a rectangular aperture having a width slightly greater than the width of the strap and having a height slightly greater than the thickness of the end region where the said adjacent layers of strap are permanently fixed together, the method comprising the step of inserting the end regions through the aperture, compressing part of the end region where the adjacent layers of strap are not permanently fixed together so that it will pass through the aperture and permitting the compressed region to re-expand.

In order that the invention may be more readily understood, and so that further features thereof may be appreciated,. the invention will now be described, by way of example, with reference to the accompanying drawings in which:

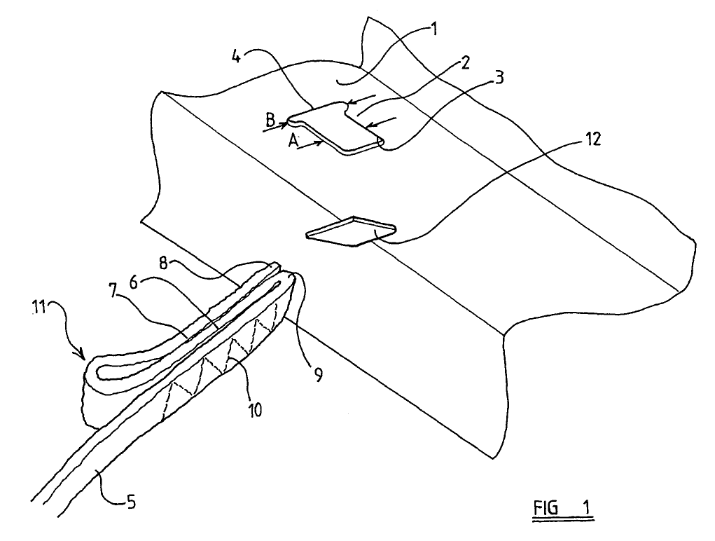

FIG. 1 is a perspective view illustrating part of a motor vehicle, and an end portion of a strap in a first relative position,

FIG. 2 is a view corresponding to FIG. 1 illustrating the end portion of the strap being inserted through an aperture,

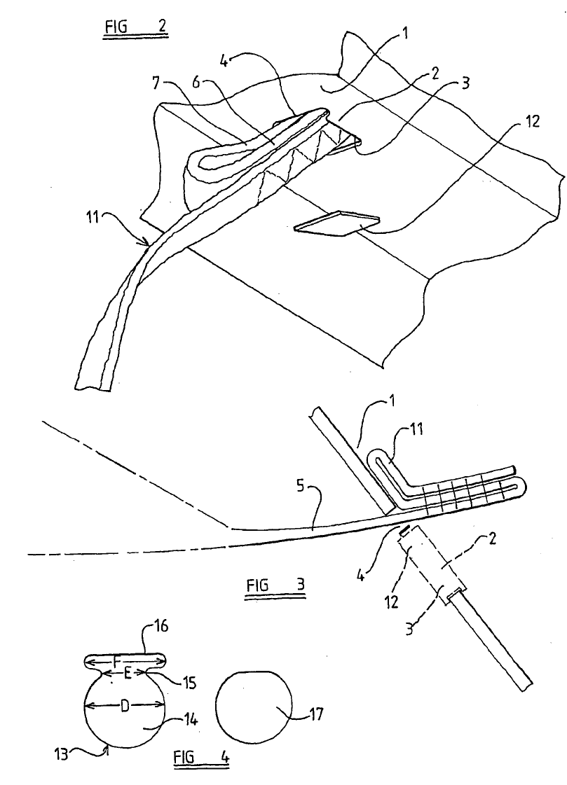

FIG. 3 is a sectional view through the aperture showing a final condition of the strap,

FIG. 4 is a diagrammatic view of an alternate form of aperture.

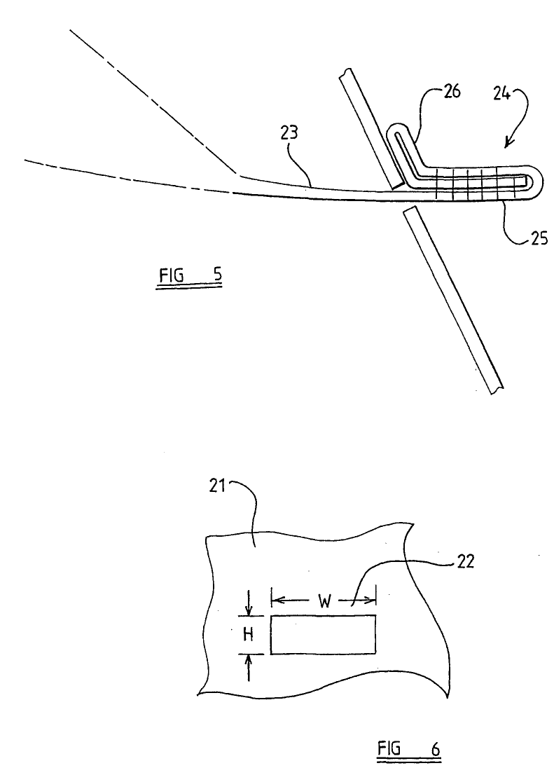

FIG. 5 is a view corresponding to FIG. 3 showing a further embodiment of the invention, and

FIG. 6 is a front view of the aperture of FIG. 5.

Referring initially to FIG. 1 of the accompanying drawings, an A-Post of a motor vehicle is illustrated. An aperture 2 is formed in the A-Post of a motor vehicle. The aperture includes a first region 3 shown to be of generally rectangular form having a predetermined width “A”, which may be 9 mm. One end of the rectangular region 3 is enlarged, to form the terminal region 4 which has an enlarged width “B”, which may be 11-12 mm.

A strap 5 is illustrated in the form of a webbing strap. The webbing strap has a predetermined width, for example 10 mm and a predetermined thickness, which may be about 1.6 mm. The terminal region of the strap 6 has been folded back to lie adjacent the main body part of the strap, and the end part 7 of the terminal region has been folded back to lie adjacent the rest of the terminal region. Thus, the end region of the strap comprises three thicknesses of strap, with the very end 8 of the strap substantially aligned with a bend 9 between the main body of the strap and the folded back terminal region 6 of the strap.

A substantial portion of this region where three thicknesses of strap is provided is stitched together by means of stitching 10. The thickness of the stitched region is about 5 mm. However, the stitching 10 does not cover the whole of the region, and thus a certain length of the super-imposed terminal region 6 and the end part 7 thereof forms a tab 11 which lies adjacent the main strap, but is not stitched thereto. In the region where the three superimposed thicknesses of strap are not stitched together, due to the natural resilience of the material forming the strap, the three adjacent. layers tend to separate from each other, and the thickness of this region may be of the order of 8 mm. However, this region may be resiliently compressed to. have a lesser thickness if pressure is applied to the strap when compressing pressure is removed the region returns to its initial form.

It is to be understood that the width “A” of the aperture 3 has been selected so that the illustrated end part of the strap 5 may be inserted into the aperture 2 in one orientation with the width of the strap being transverse to the width of the aperture. Also the width “B” has been selected to be slightly greater than the width of the main body of the strap 5. The width “A” has been selected to be less than the width of the main body of the strap 5. The terminal region 4 of the aperture 2 has a section which is slightly larger than the cross-section of the main body of the strap 5.

A snap-in cover 12 is provided, dimensioned to be snap-fitted into the main region 3 of the aperture 2.

The strap 5 may be connected to part of an air-bag or inflatable element, part of which is shown in phantom. The inflatable element is preferably an inflatable element that can form a side curtain in a motor vehicle. GB-A-2,297,950 provides a description of examples of inflatable elements that can form side curtains.

Referring to FIG. 2, it can be seen that the end part of the strap 5 is being inserted into the aperture 2. When the entire end region of the strap that has three thicknesses has been inserted into the aperture, the main body of the straps may be manipulated so as to lie solely within the terminal region 4 of the aperture 2. The region 4 is dimensioned to accommodate simply the single thickness of strapping that forms the main body of the strap 5. If there is any tendency to withdraw the strap 5 from the aperture 2, the tab 11 will engage the part of the A-Post adjacent the periphery of the aperture 2, as shown in FIG. 3, thus preventing the end of the strap from being withdrawn from the aperture 2. Thus the strap 5 may extend tightly from the A-Post 1 to an inflatable element, such as the inflatable element shown in phantom in FIG. 3. The strap 5 will not tend to pass into the rectangular region 3 of the aperture, since the part of that region 3 adjacent the terminal region 4 has a width less than the width of the strap 5.

When the strap 5 is in position, the snap-in cover may be snapped in position which will ensure that the strap stays in place within the terminal region 4. The cover 12 is shown in position in phantom in FIG. 3.

Whilst the invention has been described with reference to an embodiment in which a particular shape of aperture has been provided, FIG. 4 illustrates an alternative aperture 13. The aperture 13 has a first region 14 of generally circular form having a diameter D sufficient to enable the end of a strap, such as the strap 5 shown in FIG. 1, to be inserted into the aperture. The region 14 is separated by a relatively narrow neck 15, having a width E, from a further region 16 having a width F. The width F of the region 16 is selected to be greater than the width of the single webbing that forms the main part of the strap 5, and the region 14 thus corresponds with the region 4 of the aperture 2 being dimensioned to snugly receive one thickness of the strap that forms the main body of the strap 5. The width E is less than the width of the strap. A snap-in cover 17 may be provided to be snapped into the region 14.

It is to be appreciated that in use of the embodiment illustrated in FIG. 4 the end region of the strap will be inserted through the circular first region 14 of the aperture 13. When the end region has been passed completely through the aperture the single webbing that forms the main part of the strap that is then passing through the aperture 13 will be manipulated so that it lies solely within the further region 16. The snap-in cover may then be located in position within the circular region 14, thus serving to retain the single webbing forming the main body of the strap 5 within the further region 16. Any tension applied to the main body of the strap by tending to withdraw the strap from the aperture will cause the tab 11 to engage part of the A-post adjacent the periphery of the aperture 13 in a manner similar to that illustrated in FIG. 3.

FIGS. 5 and 6 illustrate an alternative embodiment of the invention in which the A-post 21 of the vehicle is provided with an aperture 22. In this embodiment the aperture 22 is a rectangular aperture having a height H of 7 mm and a width W of 11-12 mm. A strap 23 is provided which is similar to the strap 5 of the embodiment described with reference to FIGS. 1 to 3. The strap 23 has an end region 24 in which the very end part of the strap is folded back upon itself and is then folded back again to form a terminal region where three layers of strap are superimposed. The end part 25 of the terminal region is provided with stitching where the three superimposed layers of strap are stitched together. Extending from the end part 25 is an unstitched tab 26 formed by two of the folded back layers. The tab 26 may move to a position in which it is slightly separated from the main part of the strap 23. The strap 23 may have a width of 10 mm. The stitched part 25 of the terminal region 24 may have a thickness of 5 mm, and the thickness of the tab 26 and the adjacent part of the strap 23 may be approximately 8 mm, due to the natural resilience of the webbing forming the strap.

The terminal region 24 may be introduced into the aperture 6. The width of the terminal region 24 is less than the width of the aperture 22 and the thickness of the stitched part 25 of the terminal region 24 is less than the height of the aperture 22. Thus the terminal part of the end region 24 may be easily introduced into the aperture 22. As the terminal region 24 continues to be inserted into the aperture 22, the aperture 22 will serve to compress slightly the combination of the tab 26 and the adjacent part of the main body of the strap 23. Thus the entire end region 24 may be inserted through the aperture 22. If, subsequently, a force is applied to the main part 23 of the strap tending to withdraw the end region 24 back through the aperture 22, because the tab 26 will have re-expanded to its initial condition, the tab will engage part of the A-post 21 of the vehicle adjacent the periphery of the aperture 22 thus preventing the end region 24 from passing back out through the aperture. As in the previously described embodiments the strap 23 may be connected to part of an inflatable element, as shown in phantom in FIG. 5.

In the present specification “comprise” means “includes or consists of” and “comprising” means “including or consisting of”.

1. A strap connection comprising a strap and an aperture formed in part of the motor vehicle, the strap comprising a substantially flat strap having a terminal part folded over at least once to create an end region comprising at least two adjacent layers of strap, the said adjacent layers of strap being permanently fixed together over at least part of the region in which they are adjacent, the aperture being configured and dimensioned to permit the end region of the strap to be inserted through the aperture and to accommodate and retain the flat strap so that when a force is applied to the strap tending to withdraw the strap from the aperture the end region of the strap will engage part of the vehicle adjacent the periphery of the aperture to prevent the end region passing through the aperture.

2. A connection according to claim 1 wherein the end of the strap is folded over twice to create said end part, the end part thus having three layers of strap.

3. A connection according to claim 1 or 2 wherein the adjacent layers of strap are permanently fixed together by stitching.

4. A connection according to any one of the preceding claims wherein the said adjacent layers are permanently fixed together only over a part of the region in which they are adjacent to define a free tab adjacent the main part of the strap, the free tab being adapted to be the component of the end region to engage the part of the vehicle adjacent the periphery of the aperture.

5. A connection according to any one of the preceding claims wherein the aperture has a first region dimensioned to permit the end region of the strap to be inserted therethrough and a second region, which is connected to the first region, which is dimensioned to accommodate and retain the main body of the flat strap.

6. A connection according to claim 5 wherein the first region and the second region are interconnected by a zone having a width less than the width of the strap.

7. A connection according to claim 5 or 6 wherein a cover is provided adapted to cover the part of the aperture not occupied by the strap when the strap is in the second region.

8. A connection according to any one of claims 1 to 4 wherein the aperture is a substantially rectangular aperture having a predetermined width and a predetermined height, the width being slightly greater than the width of the flat strap.

9. A connection according to claim 8 wherein the height of the aperture is greater than the thickness of the end region where said layers of said strap are fixed together, the end region having a part where the layers are not fixed together, that part having an initial thickness greater than the height of the aperture, but being resiliently compressible.

10. A connection according to any one of the preceding claims wherein the strap is connected to an inflatable element in the form of an inflatable side curtain.

11. A connection according to claim 9 wherein the aperture is formed in the A-Pillar of the car body.

12. A method of connecting a substantially flat strap to an aperture formed in part of a motor vehicle, the method comprising the steps of folding a terminal part of the strap over at least once to create an end region comprising at least two adjacent layers of strap and permanently fixing the adjacent layers of strap together at least over a part of the region in which they are adjacent, inserting the end region through the aperture and positioning the strap so that when a force is applied to the strap tending to withdraw the strap from the aperture the end region of the strap will engage part of the vehicle adjacent the periphery of the aperture to prevent the end region passing through the aperture.

13. A method according to claim 12 wherein the end of the strap is folded over twice to create the end region, the end region thus having three layers of strap.

14. A method according to claim 12 or 13 wherein the adjacent layers of straps are permanently fixed together by stitching.

15. A method according to any one of claims 12 to 14 wherein the adjacent layers are permanently fixed together only over the part of the region in which they are adjacent to define in the other part of the region a free tab adjacent the main strap, the free tab being the component of the end region which engages the part of the vehicle adjacent the periphery of the aperture when said force is applied to the strap tending to withdraw the strap from the aperture.

16. A method according to any one of claims 12 to 15 wherein the aperture is provided with a first region dimensioned to permit the end region of the strap to be inserted therethrough and a second region to accommodate and retain the flat strap, the method comprising the steps of inserting the end region of the strap through the first region of the aperture and manipulating the flat strap so that it is located in the second region of the aperture.

17. A method according to any one of claims 12 to 16 wherein the aperture is a rectangular aperture having a width slightly greater than the width of the strap and having a height slightly greater than the thickness of the end region where the said adjacent layers of strap are permanently fixed together, the method comprising the step of inserting the end regions through the aperture, compressing part of the end region where the adjacent layers of strap are not permanently fixed together so that it will pass through the aperture and permitting the compressed region to re-expand.
